(19) United States
(12) Patent Application Publication
(10) Pub. No.: US 2008/0131706 A1
(43) Pub. Date: Jun. 5, 2008

(54) Use of Polysilazanes as Permanent Anti-Fingerprint Coatings

(76) Inventors: Stefan Brand, Hirschberg-Leutershausen (DE); Andreas Dierdorf, Hofheim (DE); Hubert Liebe, Wiesbaden (DE); Andreas Wacker, Mannheim (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/884,856

(22) PCT Filed: Feb. 10, 2006
(86) PCT No.: PCT/EP06/01188

§ 371 Date: Aug. 21, 2007

(30) Foreign Application Priority Data
Feb. 26, 2005 (DE) 10 2005 008 857.0

(51) Int. Cl. B32B 15/04; C08G 77/62

(52) U.S. Cl. 428/450; 528/31; 528/38; 528/33

(57) ABSTRACT

The invention relates to the use of polysilazanes as permanent coatings on metal surfaces for the prevention of the susceptibility to fingerprints, characterized in that the polysilazane is in the form of a solution of a polysilazane or a mixture of polysilazanes of the general formula 1

—(SiR′R″—NR′″)ₙ— (1)
where R′, R″, R′″ independently=H, optionally-substituted alkyl-, aryl, vinyl- or (trialkoxysilyl)alkyl, n=a whole number such that the polysilazane has a number-average molecular weight of from 150 to 150,000 g/mol in a solvent. The invention further relates to a method for production of the coating.

The present invention relates to the use of polysilazanes as permanent anti-fingerprint coatings.

Objects which have metal surfaces, for example of stainless steel, aluminum or chromium-plated surfaces, are widespread. These surfaces may fulfill a decorative purpose, as in everyday items, in the household, in the automobile or architecture sector and in furniture. Moreover, these metal surfaces may have particular use properties, such as good cleanability, low soiling or corrosion resistance. These use properties are of relevance in the commercial sector, for example in trade, in gastronomy, in the clinical sector or in industries such as the food-processing or chemical/pharmaceutical industry.

These metal surfaces are frequently surface-treated, i.e. brushed, polished or otherwise provided with surface structures in order to achieve particular optical effects or use properties, and used without a further coating.

Such metal surfaces are very prone to soiling of organic nature, for example by residues of foods, greases and in particular fingerprints. Such soiling is perceived very readily on the metal surfaces and influences the decorative effect or signals to the observer that the surface appears dirty and unhygienic. An additional factor is that fingerprints in particular, owing to their composition consisting of substances including grease, proteins, sweat and organic acids, can cause damage to the metal surface if they are not removed in a timely manner. This is attributable to the chemical reaction of the constituents of the fingerprint with the metal surface, which changes the appearance of the surface in a lasting manner. In the case of structured surfaces, for example those composed of brushed stainless steel, cleaning is additionally hindered by the profile of the surface.

For the prevention of soiling by fingerprints by means of a coating, the literature describes various methods. Such a coating is referred to as an anti-fingerprint coating. An ideal anti-fingerprint coating should be easy to apply and to cure, and should show permanence and very good adhesion on the metal surface. Furthermore, it is desirable that the coating is visually imperceptible and does not impair the original high-quality appearance of the surface.

The effect of an anti-fingerprint coating should consist in reducing the adhesion of fingerprints on the coated surface in order that fingerprints can be perceived to a lesser degree. The cleaning of the metal surface should be possible in a simple manner, ideally without the aid of detergents. Moreover, the coating should protect the underlying metal surface from chemical reaction by the constituents of the fingerprints, so that fingerprints present can be removed again even after a prolonged period without any remaining change in the metal surface being perceptible.

WO 02/40604A2 describes a transparent temporary anti-fingerprint coating on an aqueous basis. Such a coating can be detached again from the surface after a short time and therefore does not offer permanent protection.

WO 03/22495A1 describes a coating composition for metallic surfaces based on acrylate, which has to be cured by UV radiation. The corresponding coating is applied in relatively thick layers, such that it is visually perceptible. Moreover, UV curing is associated with a high level of apparatus complexity and can therefore be performed only when the appropriate equipment is available and is therefore correspondingly expensive.

WO 03/46090A2 describes the use of an aqueous wax emulsion as an anti-fingerprint coating. Such a coating is likewise not permanent, since there is no chemical bond to the surface.

It was an object of the present invention to develop a highly transparent anti-fingerprint coating for metal surfaces which is easy to apply and permanent and leads to fingerprints adhering less readily to the surface and hence affecting the visual appearance to a lesser degree. Moreover, removal of the fingerprints should be facilitated. Furthermore, the coating should prevent the chemical reaction of the constituents of the fingerprint with the metal surface, such that residues of fingerprints can be removed again without residue even after a prolonged period.

It has now been found that, surprisingly, coatings based on polysilazane satisfy these requirements.

The invention therefore provides for the use of polysilazanes for the coating of metal surfaces, comprising a solution of a polysilazane or a mixture of polysilazanes of the general formula 1

—(SiR′R″—NR′″)ₙ- (1)

where R′, R″, R′″ are the same or different and are each independently hydrogen or an optionally substituted alkyl, aryl, vinyl or (trialkoxysilyl)alkyl radical, where n is an integer and n is such that the polysilazane has a number-average molecular weight of from 150 to 150,000 g/mol, in a solvent.

Particularly suitable polysilazanes are in this case those polysilazanes in which R′, R″, R′″ are each independently a radical from the group of hydrogen, methyl, ethyl, propyl, isopropyl, butyl, isobutyl, tert-butyl, phenyl, tolyl, vinyl or 3-(triethoxysilyl)propyl, 3-(trimethoxysilylpropyl).

In a preferred embodiment, perhydropolysilazanes of the formula 2 are used for the inventive coating

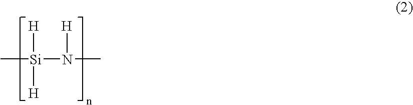

where n is an integer and n is such that the polysilazane has a number-average molecular weight of from 150 to 150,000 g/mol, and comprises a solvent.

In a further preferred embodiment, the inventive coating comprises at least one polysilazane of the formula (3)

—(SiR′R″—NR′″)ₙ—(SiR*R**—NR***)ₚ- 3)

where R′, R″, R′″, R*, R** and R*** are each independently hydrogen or an optionally substituted alkyl, aryl, vinyl or (trialkoxysilyl)alkyl radical, where n and p are each integers and n is such that the polysilazane has a number-average molecular weight of from 150 to 150,000 g/mol.

Especially preferred are compounds in which
R′, R′″ and R*** are each hydrogen and R″, R* and R** are each methyl;
R′, R′″ and R*** are each hydrogen and R″, R* are each methyl and R** is vinyl;
or
R′, R′″, R* and R*** are each hydrogen and R″ and R** are each methyl.

Preference is likewise given to solutions which comprise at least one polysilazane of the formula (4)

—(SiR′R″—NR′″)ₙ—(SiR*, R**—NR***)ₚ—(SiR¹, R²—NR³)_{q}- (4)

where R′, R″, R′″, R*, R**, R***, R¹, R² and R³ are each independently hydrogen or an optionally substituted alkyl, aryl, vinyl or (trialkoxysilyl)alkyl radical, where n, p and q are each integers and n is such that the polysilazane has a number-average molecular weight of from 150 to 150,000 g/mol.

Especially preferred are compounds in which
R′, R′″ and R*** are each hydrogen and R″, R*, R** and R² are each methyl, R³ is (triethoxysilyl)propyl and R¹ is alkyl or hydrogen.

In general, the proportion of polysilazane in the solvent is from 1 to 80% by weight of polysilazane, preferably from 5 to 50% by weight, more preferably from 10 to 40% by weight.

Suitable solvents for the polysilazane formulation are particularly organic solvents which do not comprise any water or any reactive groups (such as hydroxyl or amine groups). They are, for example, aliphatic or aromatic hydrocarbons, halohydrocarbons, esters such as ethyl acetate or butyl acetate, ketones such as acetone or methyl ethyl ketone, ethers such as tetrahydrofuran or dibutyl ether, and mono- and polyalkylene glycol dialkyl ethers (glymes), or mixtures of these solvents.

An additional constituent of the polysilazane formulation may be further binders, as are typically used for the preparation of coatings. They may, for example, be cellulose ethers and esters, such as ethylcellulose, nitrocellulose, cellulose acetate or cellulose acetobutyrate, natural resins such as rubber or rosins or synthetic resins, such as polymerization resins or condensation resins, for example amino resins, especially urea- and melamine-formaldehyde resins, alkyd resins, acrylic resins, polyesters or modified polyesters, epoxides, polyisocyanates or blocked polyisocyanates or polysiloxanes.

A further constituent of the polysilazane formulation may be additives which influence, for example, viscosity of the formulation, substrate wetting, film formation, sliding action or venting behavior, or inorganic nanoparticles, for example SiO₂, TiO₂, ZnO, ZrO₂ or Al₂O₃.

An additional constituent of the polysilazane formation may be catalysts, for example organic amines, acids and metals or metal salts, or mixtures of these compounds.

Catalysts are preferably used in amounts of from 0.001 to 10%, especially from 0.01 to 6%, more preferably from 0.1 to 3%, based on the weight of the polysilazane.

Examples of amine catalysts are ammonia, methylamine, dimethylamine, trimethylamine, ethylamine, diethylamine, triethylamine, n-propylamine, isopropylamine, di-n-propylamine, diisopropylamine, tri-n-propylamine, n-butylamine, isobutylamine, di-n-butylamine, diisobutylamine, tri-n-butylamine, n-pentylamine, di-n-pentylamine, tri-n-pentylamine, dicyclohexylamine, aniline, 2,4-dimethylpyridine, 4,4-trimethylenebis(1-methylpiperidine), 1,4-diazabicyclo[2.2.2]octane, N,N-dimethylpiperazine, cis-2,6-dimethylpiperazine, trans-2,5-dimethylpiperazine, 4,4-methylenebis(cyclohexylamine), stearylamine, 1,3-di(4-piperidyl)propane, N,N-dimethylpropanolamine, N,N-dimethylhexanolamine, N,N-dimethyloctanolamine, N,N-diethylethanolamine, 1-piperidinethanol, 4-piperidinol.

Examples of organic acids are acetic acid, propionic acid, butyric acid, valeric acid, caproic acid.

Examples of metals and metal compounds as catalysts are palladium, palladium acetate, palladium acetylacetonate, palladium propionate, nickel, nickel acetylacetonate, silver powder, silver acetylacetonate, platinum, platinum acetylacetonate, ruthenium, ruthenium acetylacetonate, ruthenium carbonyls, gold, copper, copper acetylacetonate, aluminum acetylacetonate, aluminum tris(ethylacetoacetate).

Depending on the catalyst system used, the presence of moisture or of oxygen may play a role in the curing of the coating. For instance, selection of a suitable catalyst system allows rapid curing to be achieved at high or low air humidity and at high or low oxygen content. The person skilled in the art is aware of these influences and will adjust the atmospheric conditions correspondingly by suitable optimization methods.

The invention further provides a process in which metal surfaces are coated with a polysilazane solution.

Finally, the invention provides the items coated in accordance with the invention.

The anti-fingerprint coating can be applied by customary coating methods, for example by spraying, dipping, flow-coating, knife-coating, coil-coating, etc.

Before the application of the coating, it is possible first to apply a primary layer which can contribute to an improvement in the adhesion of the polysilazane layer on the metal surface. Typical primers are those based on silane, for example 3-aminopropyltriethoxysilane, 3-glycidyloxypropyltriethoxysilane, 3-mercaptopropyltrimethoxysilane, vinyltriethoxysilane, 3-methacryloxypropyltrimethoxysilane, N-(2-aminoethyl)-3-aminopropyltrimethoxysilane, bis(3-triethoxysilylpropyl)amine, N-(n-butyl)-3-aminopropyltrimethoxysilane, N-(2-aminoethyl)-3-aminopropylmethyldimethoxysilane, 3-(trimethoxysilyl)-1-propanethiol, bis(3-(trimethoxysilyl)-1-propyl) disulfide, bis(3-(trimethoxysilyl)-1-propyl) tetrasulfide.

Depending on the polysilazane solution and catalyst used, the curing is effected either actually at room temperature (or lower) or at elevated temperature, but can generally be accelerated by heating.

Preference is given to curing the coating at a temperature from 10 to 300° C., preferably from 25 to 200° C. The maximum possible temperature for curing depends essentially upon the substrate onto which the coating is applied, since the polysilazanes have very high thermal stability.

In the case of metals, for example stainless steel or aluminum, these may be relatively high temperatures, and in the case of metallized plastic surfaces, by their nature, relatively low temperatures.

Apart from curing by conventional drying, the use of drying radiators based on IR or NIR technology is also possible. In this case, the wavelength range from 12 to 1.2 micrometers or from 1.2 to 0.8 micrometers is employed. Typical radiation intensities are in the range from 5 to 1000 kW/m².

The coating with the polysilazane formulation can be followed by a further aftertreatment with which the surface energy is adapted to the coating. This makes it possible to obtain hydrophilic, hydrophobic or oleophobic surfaces which influence the soiling tendency.

The anti-fingerprint coating can be used on all metal surfaces. A “metal surface” is understood here to mean a surface of an item which consists of metal at least on the surface. The surfaces may be of complete metal items or surfaces of items which are coated or jacketed with metal, for example metallized plastics or composite materials. The metal surface may have a thickness of only a few micrometers.

In principle, all noble or base metals and alloys of metals are suitable for the coating, for example iron, steel, zinc-plated steel, aluminum, chromium, nickel, zinc, titanium, vanadium, molybdenum, magnesium, copper.

The metals may be pretreated in a customary manner, for example by chromatization, chromate-free pretreatment, anodization or by vapor deposition with metal oxide layers.

It is possible with the inventive coating to achieve a very good anti-fingerprint effect with a low layer thickness. The cured polysilazane coating typically has a layer thickness of from 0.1 to 10 micrometers, preferably from 0.5 to 5 micrometers, more preferably from 1 to 3 micrometers. The coating is thus barely perceptible and does not affect the visual appearance of the metal surface.

The coating has very good adhesion to a wide variety of different metals and alloys and is therefore extremely permanent. In addition, the coating, owing to the inorganic character, is exceptionally stable to foods and drinks, chemicals, UV radiation and weathering influences.

The metal surfaces coated in accordance with the invention can be used in a wide variety of different sectors. Examples of these applications are everyday items such as cases, covers, dishware, kitchen utensils, electrical appliances, household appliances. Further examples are decorative surfaces in automobile construction, furniture surfaces, for architectural applications, interior facings, in the sanitary and kitchen sector and in the commercial sector, such as in gastronomy, the food and drink trade, and in the industrial sector, such as in the food-processing industry or chemical/pharmaceutical industry.

### EXAMPLES

The perhydropolysilazanes used are products from Clariant Japan K.K. The solvent used is di-n-butyl ether (designation NL).

The solution contains 0.75% by weight of palladium propionate based on the perhydropolysilazane as a catalyst.

The polysilazane copolymer from example 2 is prepared by reacting dimethyldichlorosilane with methyldichlorosilane in ammonia and subsequent reaction with 3-aminopropyltriethoxysilane analogously to example 1 in U.S. Pat. No. 6,652,978 B2.

In the examples which follow, parts and percentages are based on weight.

### Example 1

### Coating of a Stainless Steel Substrate with Perhydropolysilazane

A bar (3 cm×30 cm) of brushed stainless steel is spray-coated with the aid of a spray pistol with a 20% perhydropolysilazane solution of designation NL (see above). After venting at room temperature for 10 min, the substrate is aftertreated thermally in a drying cabinet (130° C. 1 h) for the purpose of curing the coating. The determination of the layer thickness gave a value of 2.1 μm.

### Example 2

### Coating of a Chromium-Plated Plastic Substrate with a Polysilazane Copolymer

A chromium-plated plastic substrate (5 cm×15 cm) is dipped into a solution consisting of 36.7 parts of polysilazane copolymer (see above), 3.0 parts of Paraloid B-48 S from Rohm & Haas, 0.2 part of Tego Glide 410 from Tego Chemie and 60.0 parts of n-butyl acetate. After pulling the substrate out and allowing excess solution to drip off, it is vented at room temperature for 5 min and then aftertreated thermally in a drying cabinet at 80° C. for 1 h.

### Example 3

### Adhesion

The adhesion of the coating is determined by crosscut testing to DIN EN ISO 2409 with subsequent adhesive tape removal, the adhesion being rated on a scale from 0 (best value) to 5 (worst value). Both coated metal surfaces from examples 1 and 2 show very good adhesion to the substrate (crosscut characteristic 0).

### Example 4

### Anti-Fingerprint Properties

A fingerprint was applied to the coated substrates from examples 1 and 2 and to the corresponding uncoated substrates by three test subjects in each case, and the appearance of the fingerprints on the coated and uncoated substrates was compared and assessed visually.

It was observed that the intensity, i.e. the visual perceptibility of the fingerprint traces on the coated substrates, is significantly lower than on the coated substrates. Subsequently, attempts were made to remove the fingerprint with a cotton cloth and another visual assessment was undertaken. In the case of the coated substrates, the fingerprint traces could be removed easily and completely by means of a cotton cloth and were visually no longer perceptible. In the case of the uncoated substrates, in spite of greater cleaning effort than in the case of the coated substrates, the fingerprint traces could not be eliminated completely.

### Example 5

### Long-Term Test

A fingerprint was applied to the coated substrates from examples 1 and 2 and to the corresponding uncoated substrates by three test subjects in each case. Subsequently, the substrates were stored at room temperature for 2 weeks. Thereafter, attempts were made to remove the fingerprint traces on the coated and uncoated substrates with isopropanol. In the case of the coated substrates, the fingerprint traces could be removed easily and completely. In the case of the uncoated substrates, in spite of a higher cleaning effort than in the case of the coated substrates, fingerprint traces were still visually perceptible.

1. A permanent coating for application to a metal surface for reducing susceptibility to fingerprints, comprising a solution of a polysilazane or a mixture of polysilazanes of the general formula 1
—(SiR′R″—NR′″)ₙ- (1)
where R′, R″, R′″ are the same or different and are each independently hydrogen or an optionally substituted alkyl, aryl, vinyl or (trialkoxysilyl)alkyl radical, where n is an integer and n is such that the polysilazane or the mixture of polysilazanes has a number-average molecular weight of from 150 to 150,000 g/mol, in a solvent.

2. The permanent coating as claimed in claim 1, wherein R′, R″, R′″ are each independently a radical selected from the group consisting of hydrogen, methyl, ethyl, propyl, isopropyl, butyl, iso-butyl, tert-butyl, phenyl, vinyl 3-(triethoxysilyl)propyl or 3-(trimethoxysilylpropyl).

3. The permanent coating as claimed in claim 1, wherein the solution comprises at least one perhydropolysilazane of the formula 2

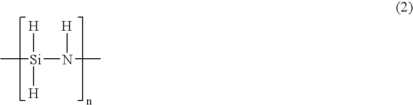

4. The permanent coating claimed in claim 1, wherein the solution comprises at least one polysilazane of the formula (3)
—(SiR′R″—NR′″)ₙ—(SiR*R**—NR***)ₚ- (3)
where R′, R″, R′″, R*, R** and R*** are each independently hydrogen or an optionally substituted alkyl, aryl, vinyl or (trialkoxysilyl)alkyl radical, where n and p are each integers and n is such that the at least one polysilazane has a number-average molecular weight of from 150 to 150,000 g/mol.

5. The permanent coating as claimed in claim 4, wherein
—R′, R′″ and R*** are each hydrogen and R″, R* and R** are each methyl.

6. The permanent coating as claimed in claim 1, wherein the solution comprises at least one polysilazane of the formula (4)
—(SiR′R″—NR′″)ₙ—(SiR*R**—NR***)ₚ—SiR¹, R²—NR³)_{q}- (4)
where R′, R″, R′″, R*, R**, R***, R¹, R² and R³ are each independently hydrogen or an optionally substituted alkyl, aryl, vinyl or (trialkoxysilyl)alkyl radical, where n, p and q are each integers and n is such that the at least one polysilazane has a number-average molecular weight of from 150 to 150,000 g/mol.

7. The permanent coating as claimed in claim 6, wherein R′, R′″ and R*** are each hydrogen and R″, R*, R** and R² are each methyl, R³ is (triethoxysilyl)propyl and R¹ is alkyl or hydrogen.

8. The permanent coating as claimed in claim 1, wherein the solution comprises from 1 to 80% by weight of the polysilazane or mixture of polysilazanes.

9. The permanent coating as claimed in claim 1, wherein the solution comprises from 0.001 to 10% by weight of at least one catalyst.

10. The permanent coating as claimed in claim 9, wherein the at least one catalyst is selected from the group consisting of organic amines, acids, metals, metal salts and a mixture thereof.

11. The permanent coating as claimed in claim 1, wherein the solvent used is an anhydrous organic solvent not containing any reactive groups.

12. The permanent coating as claimed in claim 4, wherein R′, R′41 and R*** are each hydrogen and R″, R* are each methyl and R** is vinyl.

13. The permanent coating as claimed in claim 4, wherein R′, R′″, R* and R*** are each hydrogen and R″ and R** are each methyl.

14. The permanent coating as claimed in claim 1, wherein the solution comprises from 5 to 50% by weight of the polysilazane or mixture of polysilazanes.

15. The permanent coating as claimed in claim 1, wherein the solution comprises from 10 to 40% by weight of the polysilazane or mixture of polysilazanes.

16. A process for applying a permanent coating on a metal surface for reducing susceptibility to fingerprints comprising the step of applying the permanent coating to the metal surface, wherein the permanent coating comprises a solution of a polysilazane or a mixture of polysilazanes of the general formula 1
—(SiR′R″—NR′″)ₙ- (1)
where R′, R″, R′″ are the same or different and are each independently hydrogen or an optionally substituted alkyl, aryl, vinyl or (trialkoxysilyl)alkyl radical, where n is an integer and n is such that the polysilazane or the mixture of polysilazanes has a number-average molecular weight of from 150 to 150,000 g/mol, in a solvent.

17. The process as claimed in claim 16, wherein R′, R″, R′″ are each independently a radical from the group of hydrogen, methyl, ethyl, propyl, isopropyl, butyl, iso-butyl, tert-butyl, phenyl, vinyl 3-(triethoxysilyl)propyl or 3-(trimethoxysilylpropyl).

18. The process as claimed in claim 16, wherein the solution comprises at least one perhydropolysilazane of the formula 2

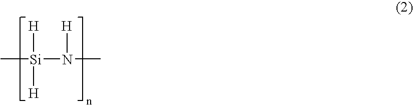

19. The process as claimed in claim 16, wherein the solution comprises at least one polysilazane of the formula (3)
—(SiR′R″—NR′″)ₙ—(SiR*R**—NR***)ₚ- (3)
where R′, R″, R′″, R*, R** and R*** are each independently hydrogen or an optionally substituted alkyl, aryl, vinyl or (trialkoxysilyl)alkyl radical, where n and p are each integers and n is such that the at least one polysilazane has a number-average molecular weight of from 150 to 150,000 g/mol.

20. A metal surface coated in accordance with the process of claim 16.
